(19) United States
(12) Patent Application Publication
(10) Pub. No.: US 2025/0103673 A1
(43) Pub. Date: Mar. 27, 2025

(54) COMBINATORIAL OPTIMIZATION PROBLEM SOLUTION DEVICE AND COMBINATORIAL OPTIMIZATION PROBLEM SOLUTION METHOD

(71) Applicant: NEC Corporation, Tokyo (JP)

(72) Inventor: Takuya ARAKI, Tokyo (JP)

(73) Assignee: NEC Corporation, Tokyo (JP)

(21) Appl. No.: 18/809,921

(22) Filed: Aug. 20, 2024

(30) Foreign Application Priority Data
Sep. 21, 2023 (JP) 2023-154091

(51) Int. Cl. G06F 17/11

(52) U.S. Cl. CPC G06F 17/11

(57) ABSTRACT

By solving SAT expressed in a form of CNF in which constraints other than a no-transformation constraint, which is a constraint that satisfies a prescribed condition among one or more constraints imposed on a combinatorial optimization problem, are transformed, so that the no-transformation constraint is satisfied, a solution unit obtains a combination of values of multiple variables of the combinatorial optimization problem, wherein the combination is a candidate of solution of the combinatorial optimization problem and satisfies the one or more constraints.

### INCORPORATION BY REFERENCE

This application is based upon and claims the benefit of priority from Japanese patent application No. 2023-154091, filed on Sep. 21, 2023, the disclosure of which is incorporated herein in its entirety by reference.

### TECHNICAL FIELD

The present disclosure relates to a combinatorial optimization problem solution device, a combinatorial optimization problem solution method, and a combinatorial optimization problem solution program. In particular, the present disclosure relates to a combinatorial optimization problem solution device, a combinatorial optimization problem solution method, and a combinatorial optimization problem solution program, which realize a speed-up of a combinatorial optimization solver called pseudo-quantum annealing.

### BACKGROUND ART

A quantum computer capable of solving combinatorial optimization problems at high speed using a quantum annealing method is being studied. The quantum computer represents a combinatorial optimization problem as the Ising model and uses quantum superposition to search for a state that minimizes an energy function corresponding to an objective function of the combinatorial optimization problem.

The quantum computer solves combinatorial optimization problems using the energy function in the Ising model as input. Examples of combinatorial optimization problems include the traveling salesman problem, the knapsack problem, the graph partitioning problem, and the nurse shift scheduling problem. Combinatorial optimization problems can also be other problems.

The Ising model is a statistical mechanical model that describes the behavior of spins in a magnetic material. In the Ising model, states of individual spins are represented by “1” or “−1”.

When a combinatorial optimization problem is solved, the spin direction changes so that the energy function in the Ising model becomes smaller. The energy function in the Ising model is expressed as in equation (1) below.

$$\begin{matrix}[ Math . 1 ] & \\ {H}_{Ising} = {\sum }_{ij} {J}_{ij} {s}_{i} {s}_{j} + {\sum }_{i} {h}_{i} {s}_{i} & equation ( 1 )\end{matrix}$$

sᵢ, sⱼ in equation (1) are variables representing the state of spin. Also, Jᵢⱼ is a constant according to i and j. Also, hi is a constant according to i.

QUBO (Quadratic Unconstrained Binary Optimization) is also known as a model in which each state of spin is represented by “1” or “0”. The energy function in the Ising model and the energy function in QUBO are mutually convertible.

The energy function in QUBO is expressed as in equation (2) below.

$$\begin{matrix}[ Math . 2 ] & \\ {H}_{QUBO} = {\sum }_{ij} {Q}_{ij} {x}_{i} {x}_{j} & equation ( 2 )\end{matrix}$$

$$( x = ( s + 1 ) / 2 )$$

xᵢ, xⱼ in equation (2) are variables representing the state of spin. In addition, Qᵢⱼ is a constant according to i and j. When the combinatorial optimization problem is solved, the orientation of the spins changes so that the energy function in QUBO becomes smaller. More specifically, when the combinatorial optimization problem is solved, the spin direction changes so that the sum of the product of the variables shown in Equation (2) multiplied by the weights is minimized.

Currently, quantum computers that are large enough to solve real-world combinatorial optimization problems have not been realized. However, with the advent of quantum computers, research is being conducted on the application of combinatorial optimization technology.

For example, in order to obtain solutions to various combinatorial optimization problems in a generalized manner, currently, the simulated annealing method (referred to as SA method below) that uses the energy function in the Ising model or in QUBO as input is used. When the SA method is used, solutions to combinatorial optimization problems can be obtained even on classical computers.

When the combinatorial optimization problem to be solved is expressed in the Ising model or QUBO, the SA method can handle various combinatorial optimization problems. Combinatorial optimization problems formulated in the Ising model or QUBO form can be solved by both quantum and classical computers.

The SA method is a general-purpose method for solving combinatorial optimization problems in an approximate manner. The SA method solves a combinatorial optimization problem as one cycle of the following four processes.
1. select one spin
2. calculate the change in energy A when flipping the selected spin
3. with transition probability min (exp(−Δ/T),1), accept flip
4. when the flip is accepted, flip the selected spin

Specifically, when the combinatorial optimization problem is expressed in QUBO format, the SA method flips the selected spin orientation, in step 2 above from “0”→“1” or “1”→“0”, and the amount of energy change Δ is calculated when the spin is flipped.

The SA method then accepts the spin flip in step 3 above when the calculated Δ is negative. When the calculated Δ is positive, the SA method accepts the spin flip with the probability calculated as above.

Next, the SA method flips the selected spin, in step 4 above when the flip is accepted. In other words, the SA method searches for a state where the energy becomes smaller while changing the direction of the spins (variables) one by one. By searching for a state where the energy becomes smaller, the SA method obtains a solution in the neighborhood. Tis a temperature parameter.

FIG. 15 is an explanatory diagram showing example of the process of solving a combinatorial optimization problem using the SA method. The curve within each rectangle shown in FIG. 15 represent the energy function. The black circle in each rectangle shown in FIG. 15 is an example of the energy value when the solution obtained by the SA method is used.

The graph shown in FIG. 15 represents the change in the temperature parameter T with the passage of time in the process of solving the combinatorial optimization problem. The graph shown in FIG. 15 represents the reduction of the temperature parameter T with the passage of time.

The SA method starts the solution process with a random combination (solution) of multiple spin orientations and transitions by evaluating nearby solutions. Since the temperature parameter T is introduced, the SA method can transition to a worse solution evaluation when Tis high temperature.

For example, as shown in FIG. 15, in the early stage of the solution process, the SA method can also cross high peaks in the energy function when T is hot. By crossing the high peaks and transitioning to a worse solution evaluation as well, the SA method can avoid finding the local optimal solution as the final solution to the combinatorial optimization problem.

As the temperature parameter T is lowered, the peaks to be crossed in the energy function become progressively lower, as in the middle stage of the solution process shown in FIG. 15. In other words, the number of transitions in the direction of poor solution evaluation is reduced.

As the temperature parameter T is further lowered, the SA method is unable to cross the peaks in the energy function. Finally, the SA method transitions with high probability to the deepest valley bottom in the energy function and stabilizes, as shown in the late stages of the solution process in FIG. 15.

The following is an explanation of the process of finding a solution to a combinatorial optimization problem, using the case of finding a solution to the traveling salesman problem using the SA method as an example. The traveling salesman problem is the problem of what order to go around each city in order to travel the minimum distance. In the traveling salesman problem, N² spins (variables) are defined for N number of cities (N is a positive integer). Each spin also indicates the presence of a salesman at point k at time t.

FIG. 16 is an explanatory diagram showing an example of a city that is the target of the traveling salesman problem. The black circles shown in FIG. 16 represent cities. The lines shown in FIG. 16 represent routes. In the case of the example shown in FIG. 16, the traveling salesman problem is to determine in what order one can travel around city A, city B, city C, and city D with the minimum travel distance.

First, an equation representing the energy in the traveling salesman problem is generated. In this example, the traveling salesman problem is represented in QUBO format. The energy function in the traveling salesman problem is generated by adding a constraint term with high weight to the objective function. The reason for adding the constraint term to the objective function is to impose a constraint condition on the optimization target (energy).

Equation (3), shown below, for example, is generated as the energy function in the traveling salesman problem.

$$\begin{matrix}[ Math . 3 ] & \\ & equation ( 3 )\end{matrix}$$

$$H = α {\sum }_{v = 1}^{n} {( 1 - {\sum }_{j = 1}^{N} {x}_{v , j} )}^{2} + a {\sum }_{j = 1}^{n} {( 1 - {\sum }_{v = 1}^{N} {x}_{v , j} )}^{2} + β {\sum }_{( uv ) ∈ E} {W}_{uv} {\sum }_{j = 1}^{N} {x}_{u , j} {x}_{v , j + 1}$$

In equation (3), j represents time. Also, v and u represent cities. In addition, x_{v,j} is a variable that represents whether or not the salesman is present in city v at time j, and corresponds to spin. That is, x_{v,j}=1 indicates that the salesman is present in city v at time j. Also, x_{v,j}=0 indicates that the salesman is not present in city v at time j.

In equation (3), Wᵤᵥ is the distance between city u and city v. Wᵤᵥ is predetermined as a constant for each pair of cities. Also, α and β are predetermined as constants.

The first term on the right-hand side in equation (3) represents the constraint that a salesman may only pass through the same city once, i.e., never more than once.

The second term on the right-hand side in equation (3) represents the constraint that salesmen can only be in one city at the same time.

The third term on the right-hand side in equation (3) represents the sum of the distances between the cities that the salesman passes through. The third term on the right-hand side is the objective function to be minimized.

Once the energy function in QUBO is obtained, the SA method identifies the state of each spin when the energy is at a minimum. Once the state of each spin when the energy is at a minimum is identified, the optimal solution to the traveling salesman problem is obtained.

FIG. 17 is a schematic diagram showing an example of the representation of the state of each spin in the traveling salesman problem. The “1” or “0” shown in FIG. 17 corresponds to the spin (variable).

The spins shown in FIG. 17 correspond, from left to right, to City A, City B, City C, and City D, respectively. Also, the spins shown in FIG. 17 correspond to time 1, time 2, time 3, and time 4, respectively, from top to bottom. In other words, FIG. 17 shows the paths around city A, city C, city B, and city D in that order.

As described above, when the energy functions in the Ising model or in QUBO are applied to SA, solutions to various combinatorial optimization problems can be obtained in a generic manner. However, when the original combinatorial optimization problem is converted to Ising model or QUBO form, the problem space, which is the range of solution search, increases.

For example, the original problem space of the traveling salesman problem is N! when the number of cities is N. However, when the traveling salesman problem is converted to Ising model form, etc., the problem space increases to the N² power of 2.

The SA method also calculates the energy change Δ for any of the many combinations of spins that do not satisfy the constraints in the problem space. When the energy change Δ becomes large due to the constraint term, the SA method removes the unconstrained combinations from the candidate of solutions.

Due to the fact that the above a is set to a large value, etc., the calculated energy change Δ becomes large even when only one spin is flipped in a combination that does not satisfy the constraint. In other words, it is difficult for the SA method to transition from one local solution to another solution due to the steepness of the solution space caused by the constraint term of the Ising model, where the energy change Δ increases too much without the constraint being satisfied even when only one spin is flipped.

For these reasons, when the SA method solves a combinatorial optimization problem using an energy function including constraint terms in the Ising model or in QUBO, the accuracy of the obtained solution may deteriorate or the computation time required to obtain an optimal or suboptimal solution may increase.

A solution system to solve the above problem flips the spins to satisfy the constraint terms.

For example, in the case of the traveling salesman problem, the above solution system uses the one-hot constraint, which ensures that only one spin in a combination of spins (variables) satisfies “1”. When the above solution system with one-hot constraint flips only one “1” spin, it also flips another “0” spin at the same time.

However, the above solution system does not address flipping spins so that all constraints are satisfied when multiple constraints are imposed on the combinatorial optimization problem.

FIG. 18 is a schematic diagram showing another example of the representation of the state of each spin in the traveling salesman problem. For example, suppose that the above solution system flips the circled variable x_{C,1}=0 in the state of each spin shown on the left in FIG. 18.

When the variable x_{C,1} flips from “0” to “1”, the above solution system flips another variable so that the variable x_{C,1} satisfies the directly related one-hot constraint. Specifically, the above solution system flips the circled variable x_{A,1} from “1” to “0” and the circled variable x_{C,2} from “1” to “0”, respectively, as shown in the state of each spin on the right side of FIG. 18.

However, when the variables x_{A,1} and x_{C,2} are flipped, as in the state of each spin shown on the right side of FIG. 18, the variables for time 2 and the variables for city A, which are surrounded by dashed lines, all become “0”. In other words, the one-hot constraint on time 2 and the one-hot constraint on city A are no longer satisfied.

As described above, it is easy for the above solution system to flip other variables so that constraints directly related to the variable to be flipped are satisfied. However, it is difficult for the above solution system to flip other variables so that other constraints not directly related to the variable to be flipped are also satisfied.

PTL 1 describes a simulated annealing device that can solve the above problem and can easily find candidates of solution that satisfy all of the multiple constraints imposed on the combinatorial optimization problem.

The simulated annealing device described in PTL 1 uses a SAT (Boolean Satisfiability Testing) solver to search for combinations of spins (variables) that satisfy all constraints imposed on the combinatorial optimization problem.

SAT is a problem of determining whether or not there exists a value that makes a given logical expression true. Also, the SAT solver is a system that solves SAT.

Also, SAT is given in CNF (Conjunctive Normal Form). SAT given in CNF form is described, for example, as in equation (4) below.

$$\begin{matrix}[ Math . 4 ] & \\ & equation ( 4 )\end{matrix}$$

$$( {x}_{1} ∨ ¬ {x}_{2} ) ∧ ( {x}_{1} ∨ {x}_{3} ∨ ¬ {x}_{4} ) ∧ ( ¬ {x}_{3} ∨ ¬ {x}_{5} ) ∧ ( ¬ {x}_{3} ∨ {x}_{5} ) ∧ ( {x}_{3} ∨ {x}_{4} )$$

Note that xᵢ in equation (4) is a variable that represents either true or false. In addition, “V”, “∨”, “∧”, and “¬” in equation (4) mean OR, AND, and NOT, respectively. In addition, (x₁∨¬x₂), etc. in equation (4) are called a clause.

That is, in SAT given in the form of CNF, clauses in which each variable is connected by OR are connected by AND together. The SAT solver returns xᵢ that satisfies SAT given in the form of CNF. If no variable satisfies SAT. The SAT solver returns that it is unsatisfiable.

The simulated annealing device described in the PTL 1 generates a combination of values of variables that satisfy the constraints in the SAT solver by regarding xᵢ as variables in QUBO and SAT given in the form of CNF as constraints imposed on the combinatorial optimization problem, respectively.

It is generally known how to express the one-hot constraint, etc. in CNF. In the generally known method, for example, the following equation (5), which is a generalized constraint (hereinafter referred to as Weighted Sum constraint), is the target of the transformation.

$$\begin{matrix}[ Math . 5 ] & \\ {w}_{1} {x}_{1} + {w}_{2} {x}_{2} + … + {w}_{n} {x}_{n} \geq k & equation ( 5 )\end{matrix}$$

By transforming “wᵢ” and “≥k” in equation (5) to “1” and “=1”, respectively, the constraint in equation (5) is transformed to the one-hot constraint.

### CITATION LIST

### Patent Literature

PTL 1: International Publication No. 2022/264414

### SUMMARY

The purpose of the present disclosure is to provide a combinatorial optimization problem solution device, a combinatorial optimization problem solution method, and a combinatorial optimization problem solution program that can obtain a candidate of solution to a combinatorial optimization problem more quickly.

A combinatorial optimization problem solution device according to the present disclosure includes a solution unit which, by solving SAT (Boolean Satisfiability Testing) expressed in a form of CNF (Conjunctive Normal Form) in which constraints other than a no-transformation constraint, which is a constraint that satisfies a prescribed condition among one or more constraints imposed on a combinatorial optimization problem, are transformed, so that the no-transformation constraint is satisfied, obtains a combination of values of multiple variables of the combinatorial optimization problem, wherein the combination is a candidate of solution of the combinatorial optimization problem and satisfies the one or more constraints.

A combinatorial optimization problem solution method according to the present disclosure includes, by solving SAT (Boolean Satisfiability Testing) expressed in a form of CNF (Conjunctive Normal Form) in which constraints other than a no-transformation constraint, which is a constraint that satisfies a prescribed condition among one or more constraints imposed on a combinatorial optimization problem, are transformed, so that the no-transformation constraint is satisfied, obtaining a combination of values of multiple variables of the combinatorial optimization problem, wherein the combination is a candidate of solution of the combinatorial optimization problem and satisfies the one or more constraints.

A non-transitory computer-readable recording medium according to the present disclosure is a non-transitory computer-readable recording medium in which a combinatorial optimization problem solution program is recorded, wherein the combinatorial optimization problem solution program causes a computer to execute: a solution process of, by solving SAT (Boolean Satisfiability Testing) expressed in a form of CNF (Conjunctive Normal Form) in which constraints other than a no-transformation constraint, which is a constraint that satisfies a prescribed condition among one or more constraints imposed on a combinatorial optimization problem, are transformed, so that the no-transformation constraint is satisfied, obtaining a combination of values of multiple variables of the combinatorial optimization problem, wherein the combination is a candidate of solution of the combinatorial optimization problem and satisfies the one or more constraints.

### BRIEF DESCRIPTION OF THE DRAWINGS

FIG. 1 It depicts a block diagram showing an example configuration of a simulated annealing device for the present disclosure.

FIG. 2 It depicts an explanatory diagram showing an example of the process by which the DPLL/CDCL execution unit 1121 solves SAT.

FIG. 3 It depicts an explanatory diagram showing an example of CNF representing SAT that is solved by the DPLL/CDCL execution unit 1121.

FIG. 4 It depicts an explanatory diagram showing an example of an implication graph generated by the DPLL/CDCL execution unit 1121.

FIG. 5 It depicts an explanatory diagram showing another example of an implication graph generated by the DPLL/CDCL execution unit 1121.

FIG. 6 It depicts an explanatory diagram showing another example of an implication graph generated by the DPLL/CDCL execution unit 1121.

FIG. 7 It depicts an explanatory diagram showing another example of an implication graph generated by the DPLL/CDCL execution unit 1121.

FIG. 8 It depicts an explanatory diagram showing another example of the process by which the DPLL/CDCL execution unit 1121 solves SAT.

FIG. 9 It depicts an explanatory diagram showing another example of an implication graph generated by the DPLL/CDCL execution unit 1121.

FIG. 10 It depicts a flowchart showing the operation of the combinatorial optimization problem solution process by the simulated annealing device 1000 of the present disclosure.

FIG. 11 It depicts a flowchart showing the operation of the SAT solution process by the SAT solution unit 1120 of the present disclosure.

FIG. 12 It depicts an explanatory diagram showing the performance of the simulated annealing device described in PTL 1 and the performance of the simulated annealing device 1000 of the present disclosure.

FIG. 13 It depicts an explanatory diagram showing an example hardware configuration of a simulated annealing device according to the present disclosure.

FIG. 14 It depicts an overview of a combinatorial optimization problem solution device according to the present disclosure.

FIG. 15 It depicts an explanatory diagram showing example of the process of solving a combinatorial optimization problem using the SA method.

FIG. 16 It depicts an explanatory diagram showing an example of a city that is the target of the traveling salesman problem.

FIG. 17 It depicts a schematic diagram showing an example of the representation of the state of each spin in the traveling salesman problem.

FIG. 18 It depicts a schematic diagram showing another example of the representation of the state of each spin in the traveling salesman problem.

### EXAMPLE EMBODIMENT

### [Description of Configuration]

The example embodiment of the present disclosure is described below with reference to the drawings. In the present disclosure, the drawings are associated with one or more example embodiments.

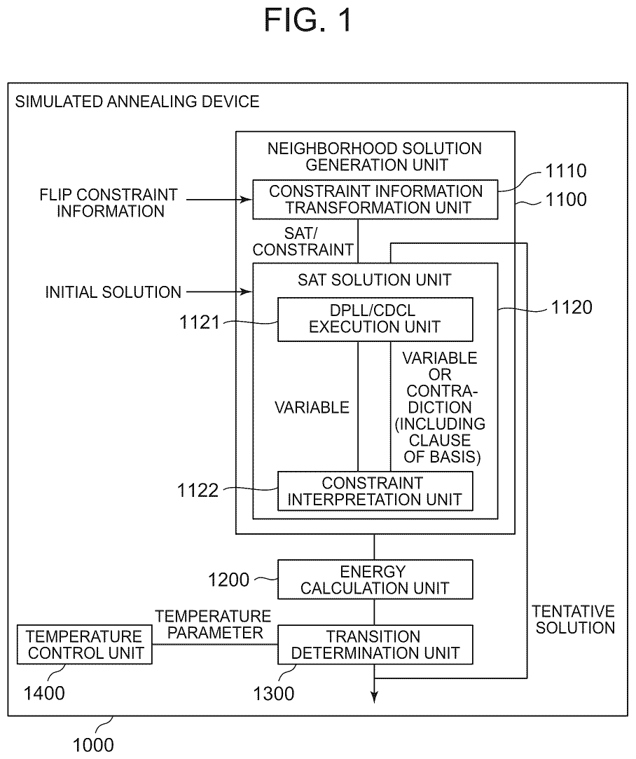

FIG. 1 is a block diagram showing an example configuration of a simulated annealing device for the present disclosure. As shown in FIG. 1, the simulated annealing device 1000 includes a neighborhood solution generation unit 1100, an energy calculation unit 1200, a transition determination unit 1300, and a temperature control unit 1400.

As shown in FIG. 1, the neighborhood solution generation unit 1100 of the present example embodiment includes a constraint information transformation unit 1110 and a SAT solution unit 1120. As shown in FIG. 1, the SAT solution unit 1120 of the present example embodiment includes a DPLL/CDCL execution unit 1121 and a constraint interpretation unit 1122.

By regarding SAT given in the form of CNF as a constraint imposed on a combinatorial optimization problem, the simulated annealing device 1000 of the present example embodiment generates a combination of variable values that satisfy the constraint in the SAT solver.

As mentioned above, the transformation of constraints into CNF may reduce the computational efficiency of the solution process by SAT solver. Among the constraints, the one-hot constraint and Weighted Sum constraint are typical and heavy constraints. The term “heavy constraints” refers to constraints that increase the time to obtain a solution using SAT given in the form of CNF because of the complexity of transformed CNF.

Therefore, when the SAT solver can handle the original constraints directly, the SAT solver can speed up the solution process. For the SAT solver to handle the original constraints directly, the SAT solver must be able to handle the one-hot constraint, Weighted Sum constraints, etc. and CNF simultaneously.

The following is an example of how the one-hot constraint is handled simultaneously with CNF. For example, to satisfy the one-hot constraint, both the at least one constraint and the at most one constraint must be satisfied. The at least one constraint can be transformed to a simple CNF where all variables are connected by OR together. Therefore, satisfying the at most one constraint is considered as an example.

For example, when one variable is set to 1, the other variables must be set to 0 in order to satisfy the at most one constraint. In other words, the other variables are determined (propagated). Also, when one variable becomes 1 and another variable is already 1, the at most one constraint is not satisfied and a contradiction occurs.

The above operations of determining variables and checking for the occurrence of contradictions are performed seamlessly with the operation of solution for SAT given in the form of CNF, so that the process of solution for SAT and the process of satisfying the constraints are performed at the same time.

The simulated annealing device 1000 of the present example embodiment is characterized by the fact that it allows the SAT solver to handle the original constraints simultaneously with CNF. The functions of each component of the simulated annealing device 1000 of the present example embodiment are described below.

The constraint information transformation unit 1110 of the neighborhood solution generation unit 1100 has the function of normalizing the constraints imposed on the combinatorial optimization problem to be solved that satisfy the prescribed condition, and transforming the constraints other than those that satisfy the prescribed condition into SAT expressed in the form of CNF.

The constraint that satisfies the prescribed condition (the “no-transformation constraint” described below) is, for example, the heavy constraint described above. That is, the time required to solve SAT expressed in the form of CNF with constraint that satisfies the prescribed condition transformed is longer than the time required to solve SAT expressed in the form of CNF with constraint other than those that satisfy the prescribed conditions transformed. The constraint that satisfies the prescribed condition is the one-hot constraint or Weighted Sum constraint.

Flip constraint information is input to the constraint information transformation unit 1110. The flip constraint information indicates the constraints imposed on the combinatorial optimization problem to be solved.

The constraint information transformation unit 1110 inputs generated SAT expressed in the form of CNF and the normalized constraint to the SAT solution unit 1120. SAT expressed in the form of CNF with transformed constraints other than those satisfying the prescribed condition may be input directly from the outside to the SAT solution unit 1120.

The SAT solution unit 1120 has the function of solving input SAT expressed in the form of CNF. The SAT solution unit 1120 inputs the candidate of solution to the combinatorial optimization problem obtained by the solution to the energy calculation unit 1200.

The energy calculation unit 1200 has the function of calculating the energy change Δ based on the input candidate of solution, which is the process of step 2 above. The energy calculation unit 1200 handles, for example, an energy function as shown in equation (3).

The energy function handled by the energy calculation unit 1200 does not have to include a constraint term. The reason for this is that the constraint term in the energy function becomes zero when the candidate of solution is substituted because the candidate of solution input to the energy calculation unit 1200 always satisfies the constraints. The energy calculation unit 1200 inputs the calculated energy change Δ to the transition determination unit 1300.

The transition determination unit 1300 has the function of determining whether or not to accept a flip of the spin in the candidate of solution using the input energy change Δ, which is the process in step 3 above. When the flip is accepted, the transition determination unit 1300 flips the spins in the candidate of solution, which is the process in step 4 above.

The temperature control unit 1400 has the function of controlling the temperature parameter T. As shown in FIG. 15, the temperature control unit 1400 decreases the temperature parameter T with the passage of time in the solution process.

Next, the specific operation of the SAT solution unit 1120 of the present example embodiment is described. The DPLL/CDCL execution unit 1121 of the SAT solution unit 1120 is a component corresponding to a SAT solver. The DPLL/CDCL execution unit 1121 solves SAT using a simulated annealing method.

In general, the SAT solver terminates the process when it has found one SAT solution. In SA, however, after one variable flips from the current combination of variables, it is required to obtain a combination that satisfies the constraints while leaving the other variables unchanged as much as possible.

The DPLL/CDCL execution unit 1121 of the present example embodiment operates according to an algorithm called DPLL (Davis-Putnam-Logemann-Loveland).

The DPLL/CDCL execution unit 1121, which follows the DPLL, looks for a determined xᵢ in SAT expressed in the form of CNF. If there is no determined xᵢ, the DPLL/CDCL execution unit 1121 selects one variable from xᵢ and determines the selected xᵢ to be true or false.

Next, the DPLL/CDCL execution unit 1121 assigns the determined xᵢ to SAT expressed in the form of CNF. The assignment of the determined xᵢ results in a new determined xᵢ.

For example, in the case of a clause (x₁∨x₂∨x₃), when x₁ and x₂ are false, then x₃ is determined to be true because the clause itself must be true. Such an operation to determine a new variable is called unit propagation. The DPLL/CDCL execution unit 1121 repeats unit propagation to obtain a combination of variables.

When a contradiction occurs, such as both ¬xᵢ and xᵢ must be true, then the determination to true or false for the variable selected earlier was wrong. Therefore, when an contradiction occurs, the DPLL/CDCL execution unit 1121 backtracks to the previously determined variable and changes the value of the variable.

Other methods for speeding up the SAT solver are also known. However, all of these methods are extensions of DPLL. The basic operation of the other methods is the same as DPLL.

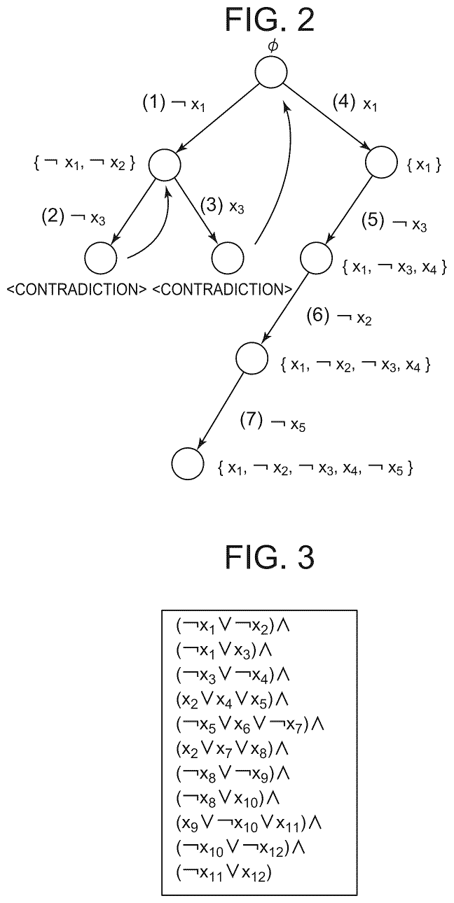

An example of the process by which the DPLL/CDCL execution unit 1121 solves SAT according to the DPLL described above is explained with reference to FIG. 2. FIG. 2 is an explanatory diagram showing an example of the process by which the DPLL/CDCL execution unit 1121 solves SAT.

In the example shown in FIG. 2, the DPLL/CDCL execution unit 1121 obtains the solution of SAT shown in equation (4). The (1), (2), . . . in FIG. 2 represent the stages of the process. The circles in FIG. 2 represent the state of the combination of variables at each stage.

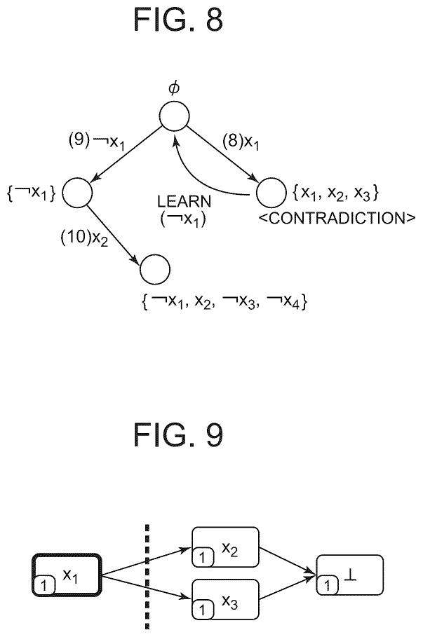

The straight arrows shown in FIG. 2 represent variable determination and change in state. Also, {xᵢ, . . . } shown in FIG. 2 represents the combination of determined variables. In addition, φ shown in FIG. 2 represents the initial state, which is the empty set. The meaning of each notation shown in FIG. 2 is the same in FIG. 8.

In the first stage (1), the DPLL/CDCL execution unit 1121 determines x₁ to be false. x₁ is determined to be false, x₂ is determined to be false by the clause (x₁∨x₂). Thus, after stage (1), the determined variable combination is {¬x₁, ¬x₂}.

In the next stage (2), the DPLL/CDCL execution unit 1121 determines x₃ to be false. x₃ is determined to be false, x₄ is determined to be false according to clause (x₁∨x₃∨¬x₄). However, according to the clause (x₃∨x₄), x₄ is determined to be true.

Because of the contradiction with respect to x₄ as described above, the DPLL/CDCL execution unit 1121 determines that the determination of x₃ was incorrect and backtracks to the previous state by one. Next, in stage (3), the DPLL/CDCL execution unit 1121 re-determines x₃ to be true.

When x₃ is determined to be true, x₅ is determined to be false by the clause (¬x₃∨¬x₅). However, according to the clause (¬x₃∨x₅), x₅ is determined to be true.

Because of the contradiction with respect to x₅ as described above, the DPLL/CDCL execution unit 1121 determines that the determination of x₁ was incorrect and backtracks to the two previous states. Next, in stage (4), the DPLL/CDCL execution unit 1121 re-determines x₁ to be true.

Even if x₁ is determined to be true, there are no variables to be determined. Therefore, after stage (4), the determined variable combination is {x₁}.

Next, in stage (5), the DPLL/CDCL execution unit 1121 determines x₃ to be false. x₃ is determined to be false, x₄ is determined to be true by the clause (x₃∨x₄). Thus, after stage (5), the determined variable combination is {x₁, ¬x₃, x₄}.

Next, in stage (6), the DPLL/CDCL execution unit 1121 determines x₂ to be false. x₂ is determined to be false, there are no variables to be determined. Therefore, after stage (6), the determined variable combination is {x₁, ¬x₂, ¬x₃, x₄}.

Next, in stage (7), the DPLL/CDCL execution unit 1121 determines x₅ to be false. When x₅ is determined to be false, all clauses are satisfied.

Therefore, after stage (7), since the combination of variables is determined as {x₁, ¬x₂, ¬x₃, x₄, ¬x₅}, the DPLL/CDCL execution unit 1121 terminates the process of obtaining solution of SAT. The process of obtaining solution of SAT is a depth-first search process as shown in FIG. 2.

As mentioned above, SA requires that after one variable flips from the current combination of variables, a combination (candidate of solution) is obtained that satisfies the constraints while leaving the other variables unchanged as much as possible. The current combination of variables is the candidate of solution {x₁, ¬x₂, ¬x₃, x₄, ¬x₅} shown in FIG. 2, or a tentative solution to the combinatorial optimization problem being sought in the SA method.

The DPLL/CDCL execution unit 1121 of the present example embodiment also operates according to an algorithm called CDCL (Conflict Driven Clause Learning).

When the DPLL/CDCL execution unit 1121, which follows CDCL, finds an contradiction when it executes DPLL, the DPLL/CDCL execution unit 1121 generates (learns) a new clause based on the variable that caused the contradiction to occur. By using the generated clause for unit propagation, the DPLL/CDCL execution unit 1121 prevents the same contradiction from occurring. In other words, CDCL is a program that improves the efficiency of the process of solving SAT.

The DPLL/CDCL execution unit 1121 also performs an operation called back jump, which performs multiple backtracks at once, simultaneously with the generation of a new clause.

The DPLL/CDCL execution unit 1121, which follows the CDCL, is also required to preserve the clauses of the unit propagation rationale when performing unit propagation.

In other words, the DPLL/CDCL execution unit 1121, which follows the CDCL, learns clauses by taking as input the clauses on which the contradiction was based when the contradiction was found and the clauses that were preserved as the basis when the unit propagation was performed.

Examples of the process by which the DPLL/CDCL execution unit 1121 solves SAT according to the CDCL described above are explained with reference to FIGS. 3 through 7. FIG. 3 is an explanatory diagram showing an example of CNF representing SAT that is solved by the DPLL/CDCL execution unit 1121.

For CNF shown in FIG. 3, the DPLL/CDCL execution unit 1121 determines x₁ to be true. x₁ is determined to be true, x₂ is determined to be false by the clause (¬x₁∨¬x₂). Also, x₃ is determined to true by the clause (¬x₁∨x₃). Also, the clause (¬x₃∨¬x₄) determines x₄ to be false. Also, the clause (x₂∨x₄∨x₅) determines x₅ to be true.

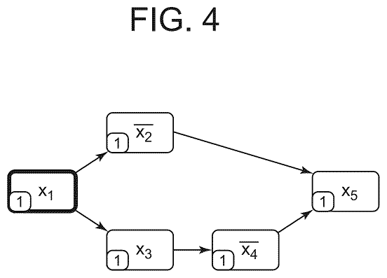

By using the rationale for determination clause, the DPLL/CDCL execution unit 1121 can generate a graph (hereafter referred to as an implication graph) in which each variable is connected to the variable that was the reason for determination. FIG. 4 is an explanatory diagram showing an example of an implication graph generated by the DPLL/CDCL execution unit 1121.

In the implication graph shown in FIG. 4, for example, x₅ is connected from x₂ and x₄ because x₅ was determined from the clause (x₂∨x₄∨x₅). The variable (x₁) surrounded by the bold frame shown in FIG. 4 is the variable whose value has been determined. In addition, the variables shown in FIG. 4 with an overline are variables that have been negated.

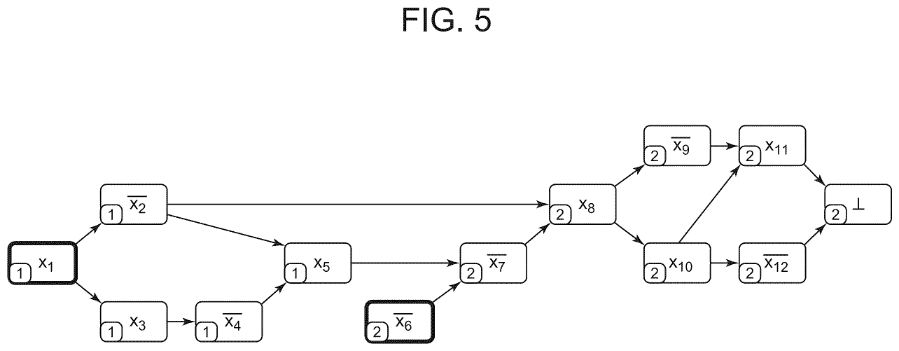

The number in the lower left corner of each variable shown in FIG. 4 represents the level of the determined variable. In the example shown in FIG. 4, the level of the determined variable is “1” because it is after the first unit propagation. The meaning of each notation shown in FIG. 4 is the same for FIGS. 5 through 7 and 9.

Next, the DPLL/CDCL execution unit 1121 determines x₆ to be false. When x₆ is determined to be false, a contradiction occurs. The implication graph when the contradiction occurs is shown in FIG. 5.

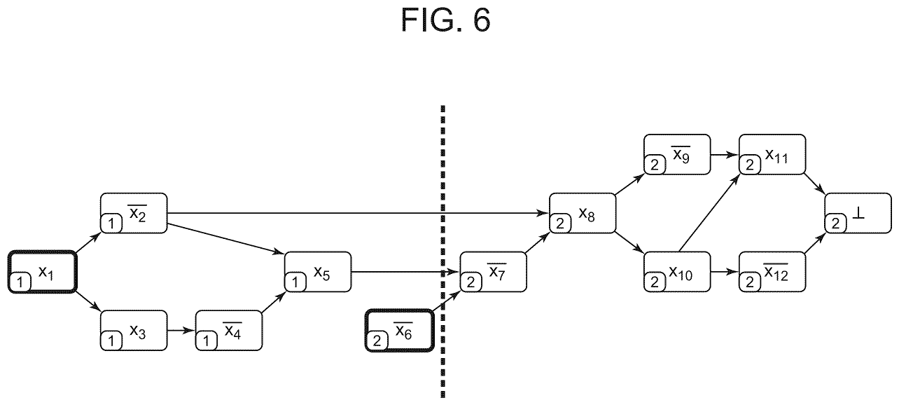

FIG. 5 is an explanatory diagram showing another example of an implication graph generated by the DPLL/CDCL execution unit 1121. The symbol “1” shown in FIG. 5 indicates a contradiction (the same in FIGS. 6-7 and 9).

Next, the DPLL/CDCL execution unit 1121 divides the implication graph shown in FIG. 5 into a set containing the contradiction and a set containing the determined variables.

FIG. 6 is an explanatory diagram showing another example of an implication graph generated by the DPLL/CDCL execution unit 1121. The DPLL/CDCL execution unit 1121 divides the implication graph at the dashed line shown in FIG. 6.

Referring to FIG. 6, the contradiction is caused by ¬x₂, x₅, ¬x₆ connected to the edge across the dashed line shown in FIG. 6. Therefore, the DPLL/CDCL execution unit 1121 learns ¬(¬x₂∧x₅∧¬x₆)=(x₂∨¬x₅∨x₆) which is negation of ¬x₂, x₅, ¬x₆.

Next, the DPLL/CDCL execution unit 1121 checks the level of the determined variables in the learned clause. The levels of the determined variables ¬x₂, x₅, and ¬x₆ are “1”, “1”, and “2”, respectively.

From the above matters, the DPLL/CDCL execution unit 1121 can know that it was able to infer the level 2 variable x₆ to be true using the learned clause even though it went back to the largest level (1) variable of all levels except the largest level (2). Therefore, the DPLL/CDCL execution unit 1121 jumps back to the level 1 variable (before determining x₆).

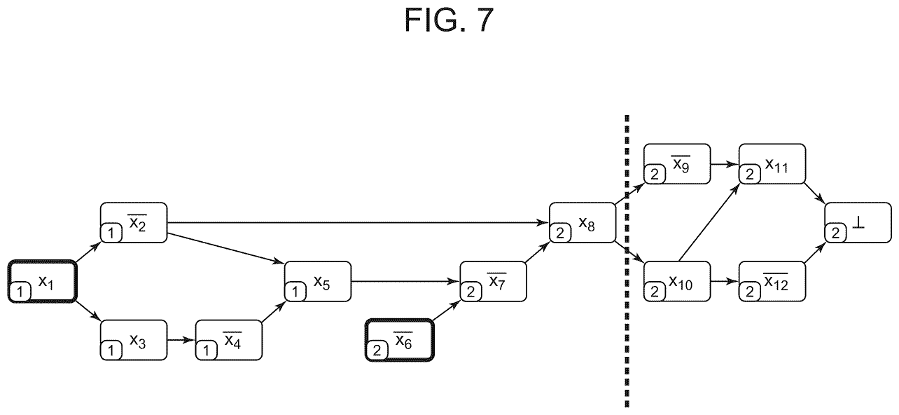

The DPLL/CDCL execution unit 1121 may also divide the implication graph at locations other than the dashed lines shown in FIG. 6. FIG. 7 is an explanatory diagram showing another example of an implication graph generated by the DPLL/CDCL execution unit 1121.

In the example shown in FIG. 7, the DPLL/CDCL execution unit 1121 learns ¬x₈. The division shown in FIG. 7 is a better division than the division shown in FIG. 6 because the learned clause is shorter. The shorter learned clause is more likely to be used because it is more general clause.

Furthermore, the fact that there is only one variable (¬x₈) in the learned clause means that x₈ can be determined false at level 0. Therefore, the DPLL/CDCL execution unit 1121 jumps back to level 0 before the determination of x₁ and determines x₈ to be false at level 0. The DPLL/CDCL execution unit 1121 may divide the implication graph at points other than the dashed line shown in FIG. 7.

As described above, the DPLL/CDCL execution unit 1121, which follows the CDCL, seeks a clause for the basis of variable determination in order to generate an implication graph when a contradiction occurs, or for unit propagation.

The SAT solution unit 1120 of the present example embodiment handles heavy constraint such as the at most one constraint directly while maintaining the above specifications. In order to handle heavy constraint directly, the constraint interpretation unit 1122 of the present example embodiment of SAT solution unit 1120 dynamically generates a clause for the basis of variable determinations. The following sections describe each of the cases of contradiction and unit propagation, respectively.

For example, it is assumed that the at most one constraint is imposed on {x₁, x₂, x₃, x₄, x₅} and x₂ and x₄ are determined to be true. x₂ and x₄ are determined to be true, which would violate the at most one constraint, resulting in a contradiction. Therefore, constraint interpretation unit 1122 dynamically generates the clause (¬x₂∨¬x₄). The constraint interpretation unit 1122 returns the contradiction to the DPLL/CDCL execution unit 1121 based on the generated clause. The process of “returning a contradiction” corresponds to the process of inputting information indicating a contradiction.

It is assumed that the same constraint as above is imposed and x₁ is false, x₃, x₄, and x₅ are not yet determined, and x₂ is determined to be true. Based on the at most one constraint, the constraint interpretation unit 1122 determines that x₃ can be determined to be false. Therefore, the constraint interpretation unit 1122 dynamically generates the clause (¬x₂∨¬x₃) and returns x₃ to the DPLL/CDCL execution unit 1121 for unit propagation to false on the basis of the generated clause.

Similarly, the constraint interpretation unit 1122 dynamically generates the clauses (¬x₂∨¬x₄) and (¬x₂∨¬x₅), respectively, and returns x₄, x₅ to the DPLL/CDCL execution 1121 for unit propagation respectively to false on the basis of each generated clause.

The operation of the SAT solution unit 1120 described above is equivalent to the operation of a SAT solver when all clauses that can be generated virtually and dynamically (in the above example, (¬x₁∨¬x₂), (¬x₁∨¬x₃), (¬x₁∨¬x₄), . . . , (¬x₄∨¬x₅)) are contained in CNF. Therefore, when the solution method of the present example embodiment is implemented in an existing SAT solver, the SAT solver can seamlessly and consistently solve SAT.

Therefore, the DPLL/CDCL execution unit 1121 of the present example embodiment performs normal unit propagation for SAT expressed in the form of CNF according to DPLL. During unit propagation, the clauses of the basis for variable determination are preserved. When a contradiction occurs, the DPLL/CDCL execution unit 1121 backtracks as usual according to CDCL.

Next, the DPLL/CDCL execution unit 1121 performs unit propagation using the heavy constraints directly. As in the case of SAT expressed in the form of CNF, the DPLL/CDCL execution unit 1121 preserves the clauses generated by the constraint interpretation unit 1122 as described above, which are the basis for variable determination. When a contradiction occurs, the DPLL/CDCL execution unit 1121 backtracks according to CDCL.

The following is a specific example of the operation of the SAT solution unit 1120 of the present example embodiment, with reference to FIG. 8. FIG. 8 is an explanatory diagram showing another example of the process by which the DPLL/CDCL execution unit 1121 solves SAT.

It is assumed that SAT to be solved by the SAT solution unit 1120 in this example is expressed in the form of CNF of the form (¬x₁∨x₂)∧(¬x₁∨x₃). Also, it is assumed that the at most one constraint is imposed on the variables {x₂, x₃, x₄}.

In the first stage (8), the DPLL/CDCL execution unit 1121 determines x₁ to be true. Next, the DPLL/CDCL execution unit 1121 performs unit propagation for CNF. That is, when x₁ is determined to be true, x₂ is determined to be true by the clause (¬x₁∨x₂). Also, when x₁ is determined to be true, x₃ is determined to be true by the clause (¬x₁∨x₃). Thus, after stage (8), the determined variable combination is {x₁, x₂, x₃} (the “tentative candidate of solution” described below).

Next, the constraint interpretation unit 1122 checks for contradiction to the at most one constraint and for determinable variables. x₂, x₃ are both determined to be true, so the constraint interpretation unit 1122 confirms that a contradiction has occurred.

Next, the constraint interpretation unit 1122 generates the clause (¬x₂∨¬x₃), which is the basis for variable determination. The constraint interpretation unit 1122 then returns the contradiction to the DPLL/CDCL execution unit 1121 on the basis of (¬x₂∨¬x₃).

The DPLL/CDCL execution unit 1121 generates an implication graph using the returned clause (x₂∨¬x₃). FIG. 9 is an explanatory diagram showing another example of an implication graph generated by the DPLL/CDCL execution unit 1121.

Based on the implication graph shown in FIG. 9, the DPLL/CDCL execution unit 1121 learns x₁. Next, the DPLL/CDCL execution unit 1121 backtracks to level 0, which is prior to the determination of x₁.

In the next stage (9), the DPLL/CDCL execution unit 1121 determines x₁ to be false based on the learned ¬x₁. When x₁ is determined to be false, there are no variables to be determined by unit propagation for CNF. In addition, the constraint interpretation unit 1122 confirms that there is no contradiction to the at most one constraint and no determinable variable either. Therefore, after stage (9), the combination of determined variables is {¬x₁} (the “tentative candidate of solution” described below).

In the next stage (10), the DPLL/CDCL execution unit 1121 determines x₂ to be true. When x₂ is determined to be true, there are no variables to be determined in the unit propagation for CNF. The constraint interpretation unit 1122 also checks that there is no contradiction to the at most one constraint.

Next, the constraint interpretation unit 1122 checks for determinable variables for the at most one constraint. Based on the at most one constraint, the constraint interpretation unit 1122 determines that x₃ is determined to be false.

Therefore, the constraint interpretation unit 1122 dynamically generates the clause (¬x₂∨¬x₃). The constraint interpretation unit 1122 then returns x₃ to the DPLL/CDCL execution unit 1121 for unit propagation to false on the basis of the generated clause.

Similarly, based on the at most one constraint, the constraint interpretation unit 1122 determines that x₄ can be determined to be false. Therefore, the constraint interpretation unit 1122 dynamically generates the clause (¬x₂∨¬x₄). The constraint interpretation unit 1122 then returns x₄ to the DPLL/CDCL execution unit 1121 for unit propagation to false on the basis of the generated clause.

Next, the DPLL/CDCL execution unit 1121 uses each returned clause (¬x₂∨¬x₃) and (¬x₂∨¬x₄) to unit propagate x₃ and x₄ to false respectively.

Thus, after stage (10), the combination of variables determined is {¬x₁, x₂, ¬x₃, ¬x₄} (the “candidate of solution” described below). Since all variables have now been determined, the SAT solution unit 1120 terminates the solution process.

Next, an example of how Weighted Sum constraint is handled simultaneously with CNF is described. For example, Weighted Sum constraint is expressed by the following equation (6).

$$\begin{matrix}[ Math . 6 ] & \\ {ax}_{1} + {bx}_{2} + {cx}_{3} … [ \leq , = , \geq ] C & equation ( 6 )\end{matrix}$$

Note that a, b, c, and C in equation (6) are all arbitrary constants. First, the constraint information transformation unit 1110 normalizes equation (6).

Specifically, the constraint information transformation unit 1110 transforms equation (6) so that only the inequality sign “≤” is used in the equation representing Weighted Sum constraint.

For example, when the equal sign “=” is used, the constraint information transformation unit 1110 prepares both an equation in which the inequality sign “≥” is used instead of the equal sign “=” and an equation in which the inequality sign “≤” is used instead of the equal sign “=”.

When the inequality sign “≥” is used, the constraint information transformation unit 1110 multiplies both sides of Equation (6) by −1.

Next, the constraint information transformation unit 1110 transforms equation (6) so that the coefficients of the equation representing Weighted Sum constraint are positive. For example, it is assumed that the equation representing Weighted Sum constraint is −ax₁ . . . ≤C with a as positive. −a(1−¬x₁) . . . ≤C, so the constraint information transformation unit 1110 can transform the equation representing Weighted Sum constraint to a ¬x₁ . . . ≤C+a. Hereafter, x₁ or ¬x₁ is denoted as l₁.

Next, the constraint information transformation unit 1110 sorts each term in the equation representing Weighted Sum constraint in order of increasing coefficient. Equation (6) is transformed, for example, as shown in Equation (7) below.

$$\begin{matrix}[ Math . 7 ] & \\ {al}_{1} + {bl}_{2} + {cl}_{3} … \leq C , & equation ( 7 )\end{matrix}$$

$$a \geq b \geq c …$$

It is assumed that the equation representing Weighted Sum constraint is al₁+bl₂+cl₃≤C (a≥b≥c), where l₂ is determined to be true, for example.

The constraint interpretation unit 1122 checks each term in the order of al₁, bl₂, and cl₃. When lᵢ is true, the constraint interpretation unit 1122 subtracts the coefficient of lᵢ from the right-hand side of the equation. For example, since l₂ is true, the right-hand side is C-b. Since there may be other variables that are true besides l₂, which is true, the constraint interpretation unit 1122 checks each term in order from left to right.

When the right-hand side becomes negative while the above confirmation is repeated, a contradiction occurs. The constraint interpretation unit 1122 makes the variable lᵢ, which is true out of the confirmed lᵢ, the variable to be included in the clause of the basis. Next, the constraint interpretation unit 1122 generates clauses (¬l₁∨¬l₂), etc.

It is possible that there is another variable that is true after the term for which the right-hand side is confirmed to be negative for the first time. However, since shorter clauses are more common and better clauses to be learned, the constraint interpretation unit 1122 does not check the remaining terms after the right-hand side is confirmed to be negative so that the learned clauses are shorter.

When the right-hand side remains positive after checking to the last term, there is no contradiction. Next, the constraint interpretation unit 1122 searches determinable variables.

The constraint interpretation unit 1122 also checks the above from the left term. Among the variables that have not yet been determined, variables whose coefficients are greater than the right-hand side are required to be false. The constraint interpretation unit 1122 returns the variables to DPLL/CDCL execution unit 1121 to unit propagation to false.

For example, when the equation for Weighted Sum constraint is 3l₁+2l₂+1l₃≤3 and l₂ is true, then the right side will be 3−2=1. In other words, the variable for terms with coefficients greater than 1 is not allowed to be true.

Therefore, when 11 is not yet determined, the constraint interpretation unit 1122 returns l₁ to the DPLL/CDCL execution unit 1121 to unit propagation to false. The basis clause is generated from the variables of the true term and the determined term. For example, the constraint interpretation unit 1122 dynamically generates the clause (¬l₁∨¬l₂).

The next section describes an example in which conditional constraints are handled simultaneously with CNF. A conditional constraint is a constraint such that the one-hot constraint or Weighted Sum constraint is imposed when any variable (spin) is 0 or 1.

To represent conditional constraints in CNF, ¬Condition ∨ may be added to each clause that constitutes CNF. For example, when CNF is (x∨y)∧(p∨q) and the variable representing the condition is c, representing that the constraint represented by CNF is imposed when c is 1 is considered. c→(x∨y)∨(p∨q) is ¬c∨((x∨y)∧(p∨q)), which is transformed into the clause (¬c∨x∨y)∧(¬c∨p∨q).

The constraint interpretation unit 1122 of the present example embodiment treats the transformed clause as it was in the original constraint meaning. Regardless of which constraint the transformed clause represents, the constraint interpretation unit 1122 checks the variables corresponding to the Condition when checking for contradiction or the presence of determinable variables.

For example, when at most one constraint is imposed on {x₁, x₂, x₃} if c is true, the constraint interpretation unit 1122 checks whether or not c is true. When c is true, the constraint interpretation unit 1122 checks for presence of contradiction or for presence of determinable variables by using the at most one constraint. When c is false or undefined, the constraint interpretation unit 1122 does nothing.

The constraint interpretation unit 1122 also generates a basis clause by including a variable equivalent to Condition. Specifically, the constraint interpretation unit 1122 adds

Condition V to the clause. For example, when c is true and x₁, x₂ is true, then the constraint interpretation unit 1122 returns contradiction to the DPLL/CDCL execution unit 1121 on the basis of the clause (¬c∨¬x₁∨¬x₂).

### [Description of Operation]

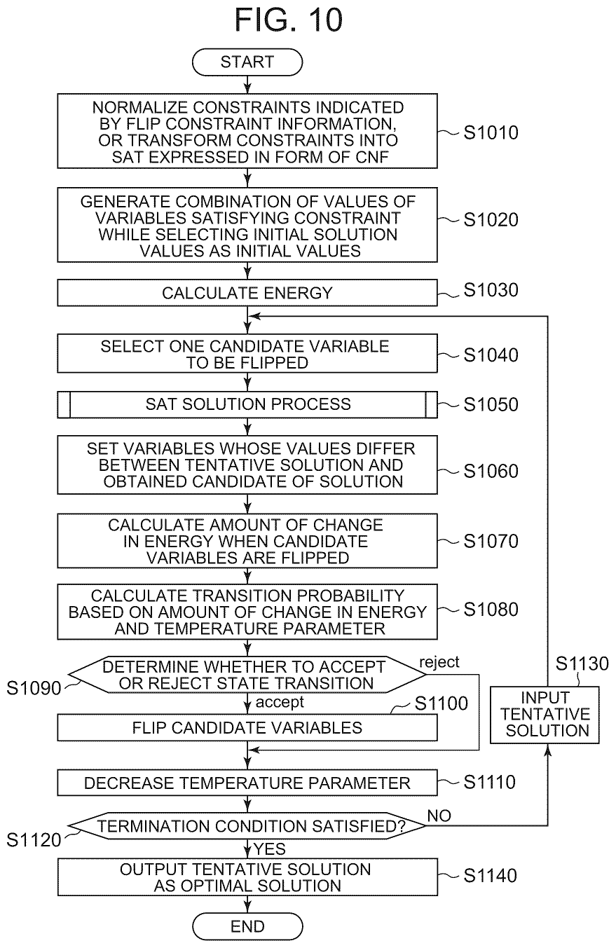

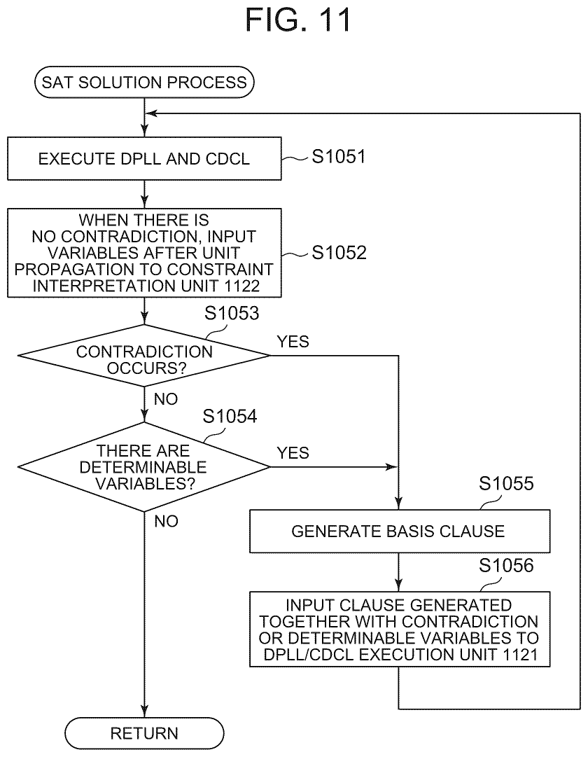

The operation of the simulated annealing device 1000 of the present example embodiment is described below with reference to FIGS. 10-11. FIG. 10 is a flowchart showing the operation of the combinatorial optimization problem solution process by the simulated annealing device 1000 of the present disclosure.

First, the flip constraint information of the combinatorial optimization problem to be solved is input to the constraint information transformation unit 1110 of the neighborhood solution generation unit 1100. The constraint information transformation unit 1110 normalizes the constraints that satisfy the prescribed condition among the constraints indicated by the input flip constraint information into a format that can be processed by the constraint interpretation unit 1122.

The constraint information transformation unit 1110 transforms the constraints indicated by the input flip constraint information, other than those that satisfy the prescribed condition, into SAT expressed in the form of CNF (step S1010). The constraint information transformation unit 1110 inputs the normalized constraints and the generated SAT to the SAT solution unit 1120.

Next, the initial solution of the generated SAT is input to the SAT solution unit 1120. The initial solution of SAT is, for example, a user-specified value (true or false) or a randomly generated set of values.

The SAT solution unit 1120 generates a combination of values of the variables by solving the input SAT while selecting the input initial solution values as initial values (step S1020). For example, the process shown in FIG. 2 is the process of step S1020.

The SAT solution unit 1120 may also solve SAT input from external sources other than the constraint information transformation unit 1110. The SAT solution unit 1120 inputs the generated combination of values of the variables to the energy calculation unit 1200. Next, the energy calculation unit 1200 calculates energy based on the input combination of values of the variables (step S1030).

Next, the SAT solution unit 1120 selects one candidate variable to be flipped from the variables included in the tentative solution (step S1040). In the first iterative process, the tentative solution is the combination of values of the variables generated in step S1020.

Next, the SAT solution unit 1120 executes SAT solution process (step S1050).

Next, the SAT solution unit 1120 sets variables whose values differ between the tentative solution and the candidate of solution obtained in step S1050 as candidate variables to be flipped (step S1060). Next, the SAT solution unit 1120 inputs the candidate of solution including the obtained candidate variables for flipping to the energy calculation unit 1200.

Next, the energy calculation unit 1200 calculates the amount of change in energy when the input candidate variables are flipped (step S1070). The energy calculation unit 1200 inputs the calculated amount of change in energy and the candidate of solution to the transition determination unit 1300.

Next, the transition determination unit 1300 calculates the transition probability based on the input amount of change in energy and the temperature parameter (step S1080).

Next, the transition determination unit 1300 determines whether to accept or reject the state transition based on the calculated transition probability (step S1090). When it is determined that the state transition is not accepted (“reject” in step S1090), the transition determination unit 1300 proceeds to step S1110.

When it is determined that the state transition is accepted (“accept” in step S1090), the transition determination unit 1300 flips the candidate variables included in the candidate of solution (step S1100). When the candidate variables are flipped, the candidate of solution becomes a tentative solution at this time.

Next, the temperature control unit 1400 decreases the temperature parameter T (step S1110).

Next, the transition determination unit 1300 determines whether the combinatorial optimization problem solution process satisfies the termination condition (step S1120). The termination condition is, for example, that the number of times steps S1040 to S1110 have been repeatedly executed reaches a predetermined number.

When the combinatorial optimization problem solution process does not satisfy the termination condition (No in step S1120), the transition determination unit 1300 inputs the tentative solution at this time to the SAT solution unit 1120 (step S1130). The SAT solution unit 1120 performs step S1040 again.

When the combinatorial optimization problem solution process satisfies the termination condition (Yes in step S1120), the transition determination unit 1300 outputs the tentative solution at this time as the optimal solution (step S1140). After the output, the simulated annealing device 1000 terminates the combinatorial optimization problem solution process.

Next, the SAT solution process in step S1050, which is a sub-process included in the combinatorial optimization problem solution process shown in FIG. 10, is explained with reference to FIG. 11. FIG. 11 is a flowchart showing the operation of the SAT solution process by the SAT solution unit 1120 of the present disclosure.

The DPLL/CDCL execution unit 1121 of the SAT solution unit 1120 first determines the values of the selected candidate variable. Next, the DPLL/CDCL execution unit 1121 solves input SAT according to DPLL while selecting the value of the tentative solution as the initial value. When a contradiction occurs during the solution, the DPLL/CDCL execution unit 1121 learns a new clause according to CDCL (step S1051).

When there is no contradiction as a result of solving SAT according to DPLL and CDCL, the DPLL/CDCL execution unit 1121 inputs the variables after unit propagation to the constraint interpretation unit 1122 (step S1052).

Next, the constraint interpretation unit 1122 determines whether the input variables generate a contradiction with respect to the normalized constraints (step S1053).

When the contradiction is generated (Yes in step S1053), the constraint interpretation unit 1122 generates a basis clause by using the variable that generated the contradiction (step S1055). Next, the constraint interpretation unit 1122 inputs the clause generated together with the contradiction to the DPLL/CDCL execution unit 1121 (step S1056). The DPLL/CDCL execution unit 1121 performs step S1051 again.

When no contradiction is generated (No in step S1053), the constraint interpretation unit 1122 determines whether or not there are determinable variables (step S1054). When there are no determinable variables (No in step S1054), the SAT solution unit 1120 returns to the combinatorial optimization problem solution process shown in FIG. 10.

When there are determinable variables (Yes in step S1054), the constraint interpretation unit 1122 generates a basis clause by using the determinable variables (step S1055). Next, the constraint interpretation unit 1122 inputs the clause generated together with the determinable variables to the DPLL/CDCL execution unit 1121 (step S1056). The DPLL/CDCL execution unit 1121 performs step S1051 again.

As described above, the SAT solution unit 1120 of the present example embodiment, by solving SAT expressed in a form of CNF in which constraints other than a no-transformation constraint, which is a constraint that satisfies a prescribed condition among one or more constraints imposed on a combinatorial optimization problem, are transformed, so that the no-transformation constraint is satisfied, obtains a combination of values of multiple variables of the combinatorial optimization problem, wherein the combination is a candidate of solution of the combinatorial optimization problem and satisfies the one or more constraints.

The SAT solution unit 1120 includes the DPLL/CDCL execution unit 1121 which obtains a tentative candidate of solution by solving SAT, and a constraint interpretation unit 1122 which determines whether or not the obtained tentative candidate of solution satisfies the no-transformation constraint.

As described above, CNF consists of one or more clauses in which one or more variables are connected. The constraint interpretation unit 1122 generates a clause by using a variable of the tentative candidate of solution which does not satisfy the no-transformation constraint, when the obtained tentative candidate of solution does not satisfy the no-transformation constraint. The DPLL/CDCL execution unit 1121 solves SAT again by using the generated clause.

The constraint interpretation unit 1122 identifies a variable whose value is determinable based on the no-transformation constraint among variables whose value of the tentative candidate of solution is not determined, when the obtained tentative candidate of solution satisfies the no-transformation constraint, and generates a clause by using identified variable. The DPLL/CDCL execution unit 1121 solves SAT again by using the generated clause.

### [Description of Effect]

The SAT solution unit 1120 of the present example embodiment solves SAT given in the form of CNF which is transformed from the constraints except for heavy constraints. In addition, the SAT solution unit 1120 can seamlessly perform the operations of determining variables based on heavy constraints and confirming the occurrence of contradictions, as well as the operation of solving SAT.

In other words, the SAT solution unit 1120 of the present example embodiment can obtain candidate of solution that also satisfy heavy constraints by solving SAT with heavy constraints removed, so the SAT solution unit 1120 can find candidate of solution to combinatorial optimization problems more quickly. The SAT solution unit 1120 of the present example embodiment has the function of an extended SAT solver.

### EXAMPLE

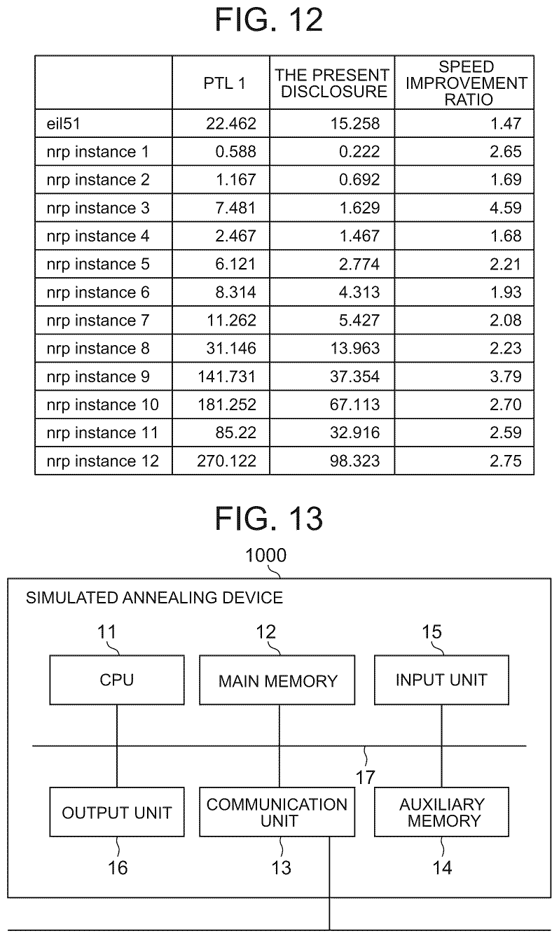

The performance of the simulated annealing device 1000 of the present example embodiment was evaluated using the traveling salesman problem and the nurse shift scheduling problem. FIG. 12 is an explanatory diagram showing the performance of the simulated annealing device described in PTL 1 and the performance of the simulated annealing device 1000 of the present disclosure.

eil51 shown in FIG. 12 is a traveling salesman problem provided by TSPLIB benchmark. eil51 was solved under the condition of 300 sweeps, all with one thread.

nrp instances 1-12 shown in FIG. 12 are the nurse shift scheduling problems provided by Nurse Rostering Benchmark Instances benchmark. nrp instances 1-12 were solved under the condition of 100 sweeps, all with 1 thread.

Note that sweep means the number of tries to flip all of each input variable. A SAT solver also has a function to start multiple threads and start the solving process with different initial values for each thread. In this example, this function is not used, so each problem was solved in a single thread.

“PTL 1” shown in FIG. 12 describes the time it took for the simulated annealing device described in PTL 1 to solve each problem. Also, “The present disclosure” shown in FIG. 12 describes the time it took for the simulated annealing device 1000 of the present example embodiment to solve each problem.

“Speed Improvement Ratio” shown in FIG. 12 describes the ratio of the time taken by the simulated annealing device described in PTL 1 to solve each problem to the time taken by the simulated annealing device 1000 of the present example embodiment to solve each problem.

As shown in FIG. 12, the simulated annealing device 1000 of the present example embodiment can solve problems 1.5 to 4.5 times faster than the simulated annealing device described in PTL 1.

Note that the constraints imposed on each problem used in this example are relatively simple constraints. The more complex the constraints imposed on each problem, the larger “Speed Improvement Ratio” shown in FIG. 12 may be.

The following is a concrete example of a hardware configuration of the simulated annealing device 1000 of the present example embodiment. FIG. 13 is an explanatory diagram showing an example hardware configuration of a simulated annealing device according to the present disclosure.

The simulated annealing device 1000 shown in FIG. 13 includes a CPU (Central Processing Unit) 11, a main memory 12, a communication unit 13, and an auxiliary memory 14. It also has an input unit 15 for user operation and an output unit 16 for presenting the processing results or progress of the processing to the user.

The simulated annealing device 1000 is realized by software, whereby the CPU 11 shown in FIG. 13 executes a program that provides the functions that each component has. In other words, each function is realized by software when the CPU 11 loads and executes the program stored in the auxiliary memory 14 into main memory 12 to control the operation of the simulated annealing device 1000.

The simulated annealing device 1000 shown in FIG. 13 may include a DSP (Digital Signal Processor) instead of the CPU 11. Alternatively, the simulated annealing device 1000 shown in FIG. 13 may include both the CPU 11 and the DSP.

The main memory 12 is used as a working area for data and as a temporary storage area for data. The main memory 12 is, for example, RAM (Random Access Memory).

The communication unit 13 has the function of inputting and outputting data to and from peripheral devices via a wired or wireless network (information communication network).

The auxiliary storage 14 is a non-transitory tangible storage medium. Examples of non-transitory tangible storage media include magnetic disks, magneto-optical disks, CD-ROM (Compact Disk Read Only Memory), DVD-ROM (Digital Versatile Disk Read Only Memory (CD-ROM), DVD-ROM (Digital Versatile Disk Read Only Memory), and semiconductor memory.

The input unit 15 has the function of inputting data and processing instructions. The input unit 15 is an input device such as a keyboard or a mouse, for example.

The output unit 16 has the function of outputting data. The output unit 16 is, for example, a display device such as a liquid crystal display device or a printing device such as a printer.

As shown in FIG. 13, in the simulated annealing device 1000, each component is connected to the system bus 17.

In the simulated annealing device 1000, the auxiliary memory 14 stores programs for realizing the neighborhood solution generation unit 1100, the energy calculation unit 1200, the transition determination unit 1300, and the temperature control unit 1400.

The simulated annealing device 1000 may be implemented with circuits containing hardware components such as LSI (Large Scale Integration) that realize the functions shown in FIG. 1 inside, for example.

The simulated annealing device 1000 may be realized by hardware that does not include computer functions using elements such as a CPU. For example, some or all of the components may be realized by general-purpose circuits (circuitry) or dedicated circuits, processors, etc. or a combination thereof. They may be configured by a single chip (e.g., the LSI described above) or by multiple chips connected via a bus. Some or all of each component may be realized by a combination of the above-mentioned circuits, etc. and programs.

Some or all of each component of the simulated annealing device 1000 may include one or more information processors equipped with an arithmetic unit and a memory unit.

When some or all of each component is realized by multiple information processing devices or circuits, etc., the multiple information processing devices or circuits, etc. may be centrally located or distributed. For example, the information processing devices and circuits may be realized as a client-and-server system, a cloud computing system, etc., each of which is connected via a communication network.

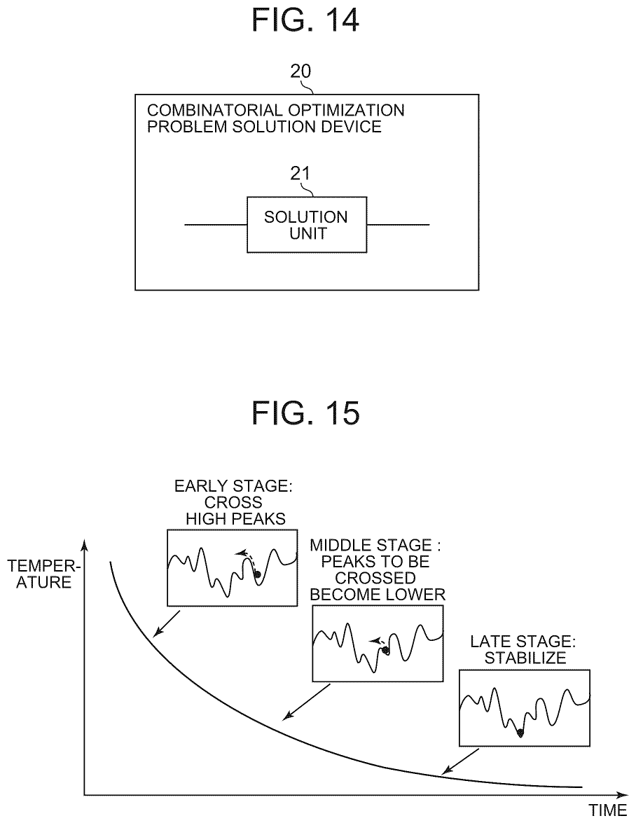

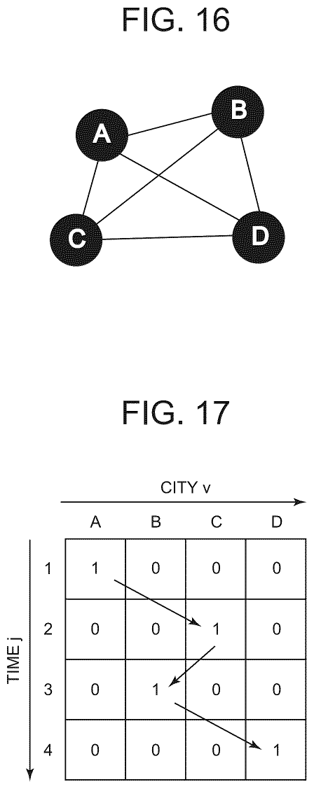

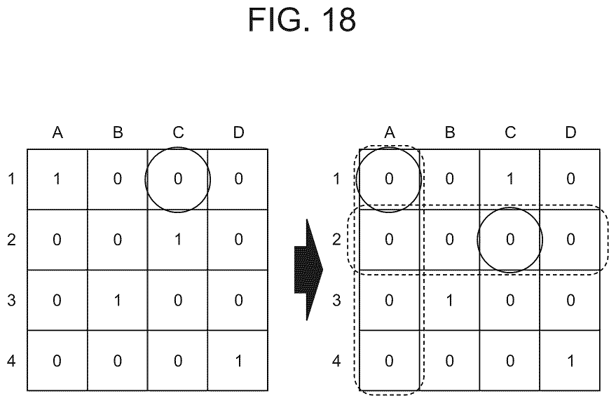

Next, an overview of the present disclosure is given. FIG. 14 is a block diagram showing an overview of a combinatorial optimization problem solution device according to the present disclosure. The combinatorial optimization problem solution device 20 according to the present disclosure includes a solution unit 21 (e.g., the SAT solution unit 1120) which, by solving SAT expressed in a form of CNF in which constraints other than a no-transformation constraint, which is a constraint that satisfies a prescribed condition among one or more constraints imposed on a combinatorial optimization problem, are transformed, so that the no-transformation constraint is satisfied, obtains a combination of values of multiple variables of the combinatorial optimization problem, wherein the combination is a candidate of solution of the combinatorial optimization problem and satisfies the one or more constraints.

Also, the solution unit 21 may include a solver (e.g., the DPLL/CDCL execution unit 1121) which obtains a tentative candidate of solution by solving SAT, and a determination unit (e.g., the constraint interpretation unit 1122) which determines whether or not the obtained tentative candidate of solution satisfies the no-transformation constraint.

Such a configuration allows the combinatorial optimization problem solution device to find a candidate of solution to combinatorial optimization problems faster.

CNF may consist of one or more clauses in which one or more variables are connected, the determination unit may generate a clause by using a variable of the tentative candidate of solution which does not satisfy the no-transformation constraint, when the obtained tentative candidate of solution does not satisfy the no-transformation constraint, and the solver may solve SAT again by using the generated clause.

With such a configuration, the combinatorial optimization problem solution device can seamlessly perform the operation of checking for the presence of contradiction and the operation of solving SAT.

The determination unit may identify a variable whose value is determinable based on the no-transformation constraint among variables whose value of the tentative candidate of solution is not determined, when the obtained tentative candidate of solution satisfies the no-transformation constraint, and generate a clause by using identified variable, and the solver may solve SAT again by using the generated clause.

With such a configuration, the combinatorial optimization problem solution device can seamlessly perform the operation of determining variables and the operation of solving SAT.

The solver may solve SAT by a simulated annealing method.

With such a configuration, the combinatorial optimization problem solution device can solve combinatorial optimization problems by a simulated annealing method.

Time required to solve SAT expressed in the form of CNF transformed from the no-transformation constraint may be longer than time required to solve SAT expressed in the form of CNF transformed from a constraint other than the no-transformation constraint. The no-transformation constraint may be one-hot constraint or Weighted Sum constraint.

Such a configuration allows the combinatorial optimization problem solution device to find a candidate of solution to combinatorial optimization problems faster.

When the combinatorial optimization problem is expressed in QUBO form, the SA method can obtain a nearby solution simply by flipping any spin as described above. However, since SAT is used, the simulated annealing device described in PTL 1 requires the use of a SAT solver to obtain a nearby solution.

When the SAT solver is used, a solution that satisfies the constraints is always obtained. However, it takes time to obtain the solution. Therefore, the simulated annealing device described in PTL 1 has the problem that it takes a long time to obtain the optimal solution to the combinatorial optimization problem itself because it takes time to obtain a neighboring solution although the constraints are guaranteed to be satisfied.

According to the present disclosure, a candidate of solution to a combinatorial optimization problem can be obtained more quickly.

Some or all of the above example embodiment may also be described as the following supplementary notes, but not limited to the following supplementary notes.
(Supplementary Note 1)

A combinatorial optimization problem solution device comprising:
a solution unit which, by solving SAT (Boolean Satisfiability Testing) expressed in a form of CNF (Conjunctive Normal Form) in which constraints other than a no-transformation constraint, which is a constraint that satisfies a prescribed condition among one or more constraints imposed on a combinatorial optimization problem, are transformed, so that the no-transformation constraint is satisfied, obtains a combination of values of multiple variables of the combinatorial optimization problem, wherein the combination is a candidate of solution of the combinatorial optimization problem and satisfies the one or more constraints.
(Supplementary Note 2)

The combinatorial optimization problem solution device according to supplementary note 1,
wherein the solution unit comprises:
a solver which obtains a tentative candidate of solution by solving SAT; and
a determination unit which determines whether or not the obtained tentative candidate of solution satisfies the no-transformation constraint.
(Supplementary Note 3)

The combinatorial optimization problem solution device according to supplementary note 2,
wherein
CNF consists of one or more clauses in which one or more variables are connected,
the determination unit generates a clause by using a variable of the tentative candidate of solution which does not satisfy the no-transformation constraint, when the obtained tentative candidate of solution does not satisfy the no-transformation constraint, and
the solver solves SAT again by using the generated clause.
(Supplementary Note 4)

The combinatorial optimization problem solution device according to supplementary note 3,
wherein
the determination unit
identifies a variable whose value is determinable based on the no-transformation constraint among variables whose value of the tentative candidate of solution is not determined, when the obtained tentative candidate of solution satisfies the no-transformation constraint, and
generates a clause by using identified variable, and
the solver solves SAT again by using the generated clause.
(Supplementary Note 5)

The combinatorial optimization problem solution device according to any one of supplementary notes 2 to 4,
wherein
the solver solves SAT by a simulated annealing method.
(Supplementary Note 6)

The combinatorial optimization problem solution device according to any one of supplementary notes 1 to 5,
wherein
time required to solve SAT expressed in the form of CNF transformed from the no-transformation constraint is longer than time required to solve SAT expressed in the form of CNF transformed from a constraint other than the no-transformation constraint.
(Supplementary Note 7)

The combinatorial optimization problem solution device according to supplementary note 6,
wherein
the no-transformation constraint is one-hot constraint or Weighted Sum constraint.
(Supplementary Note 8)

A combinatorial optimization problem solution method executed by a combinatorial optimization problem solution device,
wherein the combinatorial optimization problem solution device,
by solving SAT (Boolean Satisfiability Testing) expressed in a form of CNF (Conjunctive Normal Form) in which constraints other than a no-transformation constraint, which is a constraint that satisfies a prescribed condition among one or more constraints imposed on a combinatorial optimization problem, are transformed, so that the no-transformation constraint is satisfied, obtains a combination of values of multiple variables of the combinatorial optimization problem, wherein the combination is a candidate of solution of the combinatorial optimization problem and satisfies the one or more constraints.
(Supplementary Note 9)

The combinatorial optimization problem solution method according to supplementary note 8,
wherein the combinatorial optimization problem solution device
obtains a tentative candidate of solution by solving SAT; and
determines whether or not the obtained tentative candidate of solution satisfies the no-transformation constraint.
(Supplementary Note 10)

The combinatorial optimization problem solution method according to supplementary note 9,
wherein CNF consists of one or more clauses in which one or more variables are connected, and
wherein the combinatorial optimization problem solution device
generates a clause by using a variable of the tentative candidate of solution which does not satisfy the no-transformation constraint, when the obtained tentative candidate of solution does not satisfy the no-transformation constraint, and
solves SAT again by using the generated clause.
(Supplementary Note 11)

The combinatorial optimization problem solution method according to supplementary note 10,
wherein the combinatorial optimization problem solution device
identifies a variable whose value is determinable based on the no-transformation constraint among variables whose value of the tentative candidate of solution is not determined, when the obtained tentative candidate of solution satisfies the no-transformation constraint,
generates a clause by using identified variable, and
solves SAT again by using the generated clause.
(Supplementary Note 12)

The combinatorial optimization problem solution method according to any one of supplementary notes 9 to 11,
wherein the combinatorial optimization problem solution device
solves SAT by a simulated annealing method.
(Supplementary Note 13)

The combinatorial optimization problem solution method according to any one of supplementary notes 8 to 12,
wherein
time required to solve SAT expressed in the form of CNF transformed from the no-transformation constraint is longer than time required to solve SAT expressed in the form of CNF transformed from a constraint other than the no-transformation constraint.
(Supplementary Note 14)

The combinatorial optimization problem solution method according to supplementary note 13,
wherein
the no-transformation constraint is one-hot constraint or Weighted Sum constraint.
(Supplementary Note 15)

A non-transitory computer-readable recording medium in which a combinatorial optimization problem solution program is recorded, wherein the combinatorial optimization problem solution program causes a computer to execute:
a solution process of, by solving SAT (Boolean Satisfiability Testing) expressed in a form of CNF (Conjunctive Normal Form) in which constraints other than a no-transformation constraint, which is a constraint that satisfies a prescribed condition among one or more constraints imposed on a combinatorial optimization problem, are transformed, so that the no-transformation constraint is satisfied, obtaining a combination of values of multiple variables of the combinatorial optimization problem, wherein the combination is a candidate of solution of the combinatorial optimization problem and satisfies the one or more constraints.
(Supplementary Note 16)

The non-transitory computer-readable recording medium according to supplementary note 15,
wherein the combinatorial optimization problem solution program causes the computer to execute, in the solution process:
obtaining a tentative candidate of solution by solving SAT; and
determining whether or not the obtained tentative candidate of solution satisfies the no-transformation constraint.
(Supplementary Note 17)

The non-transitory computer-readable recording medium according to supplementary note 16,
wherein CNF consists of one or more clauses in which one or more variables are connected, and
wherein the combinatorial optimization problem solution program causes the computer to execute, in the solution process:
generating a clause by using a variable of the tentative candidate of solution which does not satisfy the no-transformation constraint, when the obtained tentative candidate of solution does not satisfy the no-transformation constraint, and
solving SAT again by using the generated clause.
(Supplementary Note 18)

The non-transitory computer-readable recording medium according to supplementary note 17,
wherein the combinatorial optimization problem solution program causes the computer to execute, in the solution process:
identifying a variable whose value is determinable based on the no-transformation constraint among variables whose value of the tentative candidate of solution is not determined, when the obtained tentative candidate of solution satisfies the no-transformation constraint,
generating a clause by using identified variable, and
solving SAT again by using the generated clause.
(Supplementary Note 19)

The non-transitory computer-readable recording medium according to any one of supplementary notes 16 to 18,
wherein the combinatorial optimization problem solution program causes the computer to execute, in the solution process:
solving SAT by a simulated annealing method.
(Supplementary Note 20)

The non-transitory computer-readable recording medium according to any one of supplementary notes 15 to 19,
wherein
time required to solve SAT expressed in the form of CNF transformed from the no-transformation constraint is longer than time required to solve SAT expressed in the form of CNF transformed from a constraint other than the no-transformation constraint.
(Supplementary Note 21)

The non-transitory computer-readable recording medium according to supplementary note 20,
wherein
the no-transformation constraint is one-hot constraint or Weighted Sum constraint.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

What is claimed is:

1. A combinatorial optimization problem solution device comprising:
a solution unit which, by solving SAT (Boolean Satisfiability Testing) expressed in a form of CNF (Conjunctive Normal Form) in which constraints other than a no-transformation constraint, which is a constraint that satisfies a prescribed condition among one or more constraints imposed on a combinatorial optimization problem, are transformed, so that the no-transformation constraint is satisfied, obtains a combination of values of multiple variables of the combinatorial optimization problem, wherein the combination is a candidate of solution of the combinatorial optimization problem and satisfies the one or more constraints.

2. The combinatorial optimization problem solution device according to claim 1,
wherein the solution unit comprises:
a solver which obtains a tentative candidate of solution by solving SAT; and
a determination unit which determines whether or not the obtained tentative candidate of solution satisfies the no-transformation constraint.

3. The combinatorial optimization problem solution device according to claim 2,
wherein
CNF consists of one or more clauses in which one or more variables are connected,
the determination unit generates a clause by using a variable of the tentative candidate of solution which does not satisfy the no-transformation constraint, when the obtained tentative candidate of solution does not satisfy the no-transformation constraint, and
the solver solves SAT again by using the generated clause.

4. The combinatorial optimization problem solution device according to claim 3,
wherein
the determination unit
identifies a variable whose value is determinable based on the no-transformation constraint among variables whose value of the tentative candidate of solution is not determined, when the obtained tentative candidate of solution satisfies the no-transformation constraint, and
generates a clause by using identified variable, and
the solver solves SAT again by using the generated clause.

5. The combinatorial optimization problem solution device according to claim 2,
wherein
the solver solves SAT by a simulated annealing method.

6. The combinatorial optimization problem solution device according to claim 1,
wherein
time required to solve SAT expressed in the form of CNF transformed from the no-transformation constraint is longer than time required to solve SAT expressed in the form of CNF transformed from a constraint other than the no-transformation constraint.

7. The combinatorial optimization problem solution device according to claim 6,
wherein
the no-transformation constraint is one-hot constraint or Weighted Sum constraint.

8. A combinatorial optimization problem solution method comprising:
by solving SAT (Boolean Satisfiability Testing) expressed in a form of CNF (Conjunctive Normal Form) in which constraints other than a no-transformation constraint, which is a constraint that satisfies a prescribed condition among one or more constraints imposed on a combinatorial optimization problem, are transformed, so that the no-transformation constraint is satisfied, obtaining a combination of values of multiple variables of the combinatorial optimization problem, wherein the combination is a candidate of solution of the combinatorial optimization problem and satisfies the one or more constraints.

9. A non-transitory computer-readable recording medium in which a combinatorial optimization problem solution program is recorded, wherein the combinatorial optimization problem solution program causes a computer to execute:
a solution process of, by solving SAT (Boolean Satisfiability Testing) expressed in a form of CNF (Conjunctive Normal Form) in which constraints other than a no-transformation constraint, which is a constraint that satisfies a prescribed condition among one or more constraints imposed on a combinatorial optimization problem, are transformed, so that the no-transformation constraint is satisfied, obtaining a combination of values of multiple variables of the combinatorial optimization problem, wherein the combination is a candidate of solution of the combinatorial optimization problem and satisfies the one or more constraints.
